(19) United States
(12) Patent Application Publication
(10) Pub. No.: US 2026/0266760 A1
(43) Pub. Date: Sep. 10, 2026

(54) ELECTROPHORESIS DEVICE

(71) Applicant: HITACHI HIGH-TECH CORPORATION, Tokyo (JP)

(72) Inventors: Katsunari Maruoka, Tokyo (JP); Takehiko Shibasaki, Tokyo (JP); Takashi Gomi, Tokyo (JP); Motohiro Yamazaki, Tokyo (JP)

(73) Assignee: HITACHI HIGH-TECH CORPORATION, Tokyo (JP)

(21) Appl. No.: 18/993,482

(22) PCT Filed: Aug. 1, 2022
(86) PCT No.: PCT/JP2022/029518

§ 371 Date: Jan. 10, 2025

(51) Int. Cl. G01N 27/447

(52) U.S. Cl. CPC G01N 27/44721

(57) ABSTRACT

An object of the present invention is to provide an electrophoresis device that suppresses the degradation of analytical performance and ensures high freedom in selecting laser devices. To do this, the present invention provides an electrophoresis device that irradiates a laser light from both ends of a capillary array composed of a plurality of capillaries lined up and detects the light from a plurality of capillaries.

An optical isolator is provided on an optical path from a light source of the laser light to the capillary array. It is possible to suppress reflected return light without irradiating the laser slantwise to the capillary axis and provide an electrophoresis device with high analytical performance. Transmitted and reflected return light can be reliably suppressed, allowing greater freedom in selecting laser devices.

### DESCRIPTION

### Technical Field

The present invention relates to an electrophoresis device.

### Background Art

A multi-focus capillary electrophoresis device irradiates both ends of a capillary array composed of a plurality of capillaries placed in a row with laser light to detect uniform signal intensity from all capillaries. Such a multi-focus system is likely to return the reflected return light and transmitted return light from the capillary to the laser unit as a light source, resulting in unstable laser oscillation and adversely affecting analytical performance.

Patent Literature 1 describes an electrophoresis device that suppresses reflected and transmitted return light. For example, FIG. 11 (sixth embodiment) of Patent Literature 1 discloses a technology that uses a polarizer and a half-wave plate to keep the laser light, irradiated from both ends of a capillary array, perpendicular to the capillary axis and suppress transmitted return light. FIG. 12 (seventh embodiment) of Patent Literature 1 discloses a technology that irradiates the laser light at an angle not perpendicular to the capillary axis to suppress reflected return light.

### CITATION LIST

### Patent Literature

Patent Literature 1: U.S. Unexamined Patent Application Publication No. 2003/0226756

### SUMMARY OF INVENTION

### Technical Problem

When the laser light passes through the capillary array and disorders the polarization state according to the technology illustrated in FIG. 11 of Patent Literature 1, the light after passing through the half-wave plate causes variations in polarization angles and some components pass through the polarizer, making it difficult to shield the transmitted return light completely. The technology concerned hardly suppresses the reflected return light and requires using a laser unit resistant to the return light, decreasing the degree of freedom in selecting laser devices. The technology illustrated in FIG. 12 of Patent Literature 1 irradiates the laser slantwise to the capillary axis and widens the irradiation region of the laser light, possibly generating false signals due to spectral shifts. The generation of false signals degrades the sample separation performance of an electrophoresis device.

An object of the present invention is to provide an electrophoresis device that suppresses the degradation of analytical performance and ensures high freedom in selecting laser devices.

### Solution to Problem

To solve the above-mentioned problem, the present invention provides an electrophoresis device that irradiates a laser light from both ends of a capillary array composed of a plurality of capillaries lined up and detects the light from the plurality of capillaries. An optical isolator is provided on an optical path from a light source of the laser light to the capillary array.

### Advantageous Effects of Invention

The present invention can provide an electrophoresis device with high analytical performance because the reflected return light can be suppressed without irradiating the laser slantwise to the capillary axis. Transmitted and reflected return light can be reliably suppressed, allowing greater freedom in selecting laser devices.

### BRIEF DESCRIPTION OF DRAWINGS

FIG. 1 is a schematic diagram illustrating an electrophoresis device according to the present embodiments.

FIG. 2 is a diagram illustrating a state in which a DNA band separated by electrophoresis moves inside the capillary.

FIG. 3 is a graph illustrating a change in the emission spectrum.

FIG. 4 is a schematic diagram illustrating a laser light path in an optical irradiation system of an electrophoresis device according to the first embodiment.

FIG. 5A is a diagram illustrating how laser light enters a polarization-dependent optical isolator in the forward direction.

FIG. 5B is a diagram illustrating how the return light enters a polarization-dependent optical isolator in the reverse direction.

FIG. 6 is a conceptual diagram illustrating transmitted and reflected return light when laser light is irradiated to a capillary array.

FIG. 7A is a diagram illustrating linear polarization states of the laser light and its transmitted return light when the laser light enters the polarization-dependent optical isolator and then is irradiated to the capillary array from below.

FIG. 7B is a diagram illustrating polarization states of the laser light and its transmitted return light when the laser light enters the polarization-dependent optical isolator and then is irradiated to the capillary array from above.

FIG. 8A is a diagram illustrating an optical path of the laser light entering the polarization-independent optical isolator in the forward direction and the polarization direction at each position as viewed from the beam travel direction.

FIG. 8B is a diagram illustrating an optical path of the return light entering the polarization-independent optical isolator in the reverse direction and the polarization direction at each position as viewed from the beam travel direction.

FIG. 9A is a diagram illustrating linear polarization states of the laser light and its transmitted return light when the laser light enters the polarization-independent optical isolator and then is irradiated to the capillary array from below.

FIG. 9B is a diagram illustrating linear polarization states of the laser light and its transmitted return light when the laser light enters the polarization-independent optical isolator and then is irradiated to the capillary array from above.

### DESCRIPTION OF EMBODIMENTS

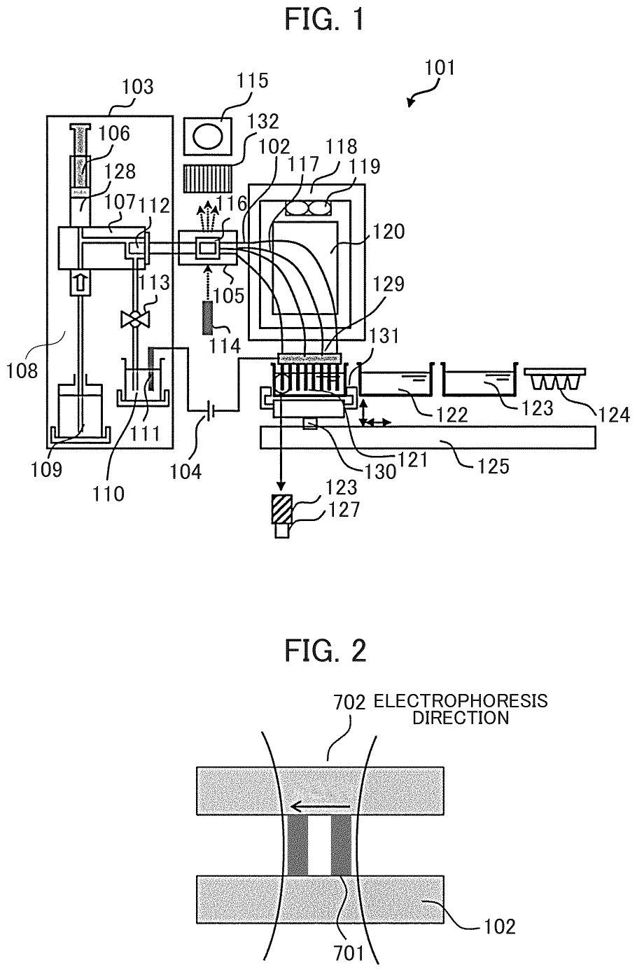

The description below explains a configuration of the electrophoresis device according to an embodiment of the present invention by reference to FIG. 1. FIG. 1 is a schematic diagram illustrating the electrophoresis device according to the present embodiments. As illustrated in FIG. 1, the electrophoresis device 101 includes a capillary array 117 composed of one or more capillaries 102, a thermostatic bath 118 to keep the capillary 102 at a constant temperature, a high-voltage power supply 104 to apply a voltage to the capillary 102, a pump mechanism 103 to inject a polymer into the capillary 102, and a transport mechanism 125. The transport mechanism 125 transports a buffer container 121, a washing container 122, a waste container 123, and a sample container 124 to a capillary cathode end 127.

The capillary array 117 includes a load header 129 at one end, a capillary head 112 at the other, and a detection portion 116 formed between the load header 129 and the capillary head 112 to detect a sample electrophoresed in the capillary 102. The capillary array 117 includes 24 capillaries 102, for example, and is replaced with another using a different capillary length when the measurement method is changed. The new capillary array 117 is also replaced with a new one if the capillary 102 is damaged or is subject to degraded quality.

The capillary 102 is made of a glass tube with an inner diameter of 50 μm and an outer diameter of 320 μm and is coated with polyimide on the surface to improve the strength. The polyimide coating is removed from the detection portion 116 of the capillary 102, where the laser light is irradiated, so that the light emitted from inside can easily leak out. The pump mechanism 103 fills the inside of the capillary 102 with a separation medium to provide an electrophoretic difference during electrophoresis. The present embodiment uses a polymer, which is a highly viscous solution, as the separation medium.

Each capillary cathode end 127 is fixed through a metal hollow electrode 126 so that the end of the capillary 102 protrudes from the hollow electrode 126 by approximately 0.5 mm. The hollow electrodes 126 provided for the capillaries 102 are all integrally attached to the load header 129. All hollow electrodes 126 are connected to the high-voltage power supply 104 mounted on the device body and function as cathode electrodes when voltage is applied for electrophoresis or sample introduction, for example.

The capillary head 112 bundles and glues the capillary cathode end 127 and the opposite capillary end together. The capillary head 112 is connected to the block 107 to be pressure-proof and airtight. The pump mechanism 103 fills the inside of the capillary 102 with new polymer. The polymer in the capillary 102 is refilled after each measurement to improve the measurement performance.

The optical system includes a light irradiation mechanism 114 to irradiate the detection portion 116, an array holder 105 to hold the detection portion 116, a spectroscope 132 to disperse the light emitted from the detection portion 116 into each wavelength, and a 2D detector 115 to detect the dispersed light. To detect a sample separated by electrophoresis in the capillary 102, the light irradiation mechanism 114 irradiates the detection portion 116, the spectroscope 132 disperses the light emitted from the detection portion 116, and the 2D detector 115 detects the dispersed light.

The thermostatic bath 118 is covered with a thermal insulating material and its inside is controlled to a constant temperature by a heating and cooling mechanism 120. A fan 119 circulates and agitates the air in the thermostatic bath 118 to maintain a uniform and constant temperature of the capillary array 117.

The pump mechanism 103 includes a plunger pump 106, a block 107, a check valve 108, a motorized valve 113, a polymer container 109, and an anode buffer container 110. The block 107 includes a flow path that connects the plunger pump 106, the polymer container 109, the anode buffer container 110, and the capillary array 117. The flow path between the plunger pump 106 and the polymer container 109 includes a check valve 108 to prevent backflow of the polymer. The flow path between the block 107 and the anode buffer container 110 includes a motorized valve 113. The motorized valve 113 closes to prevent a buffer solution from flowing from the anode buffer container 110 when the plunger pump 106 fills the chamber 128 and the capillary array 117 with polymer. During electrophoresis, the motorized valve 113 opens to energize the anode electrode 111 and the capillary cathode end 127.

The transport mechanism 125 includes three electric motors and linear actuators (unshown) and can move in three axes, namely, in vertical, horizontal, and depth directions. One or more containers can be placed on the moving stage 130 of the transport mechanism 125. The moving stage 130 also includes an electric grip 131 that can grip and release containers. The buffer container 121, the washing container 122, the waste container 123, and the sample container 124 can be transported to the load header 129 as needed. Unnecessary containers are stored in a designated storage space inside the device.

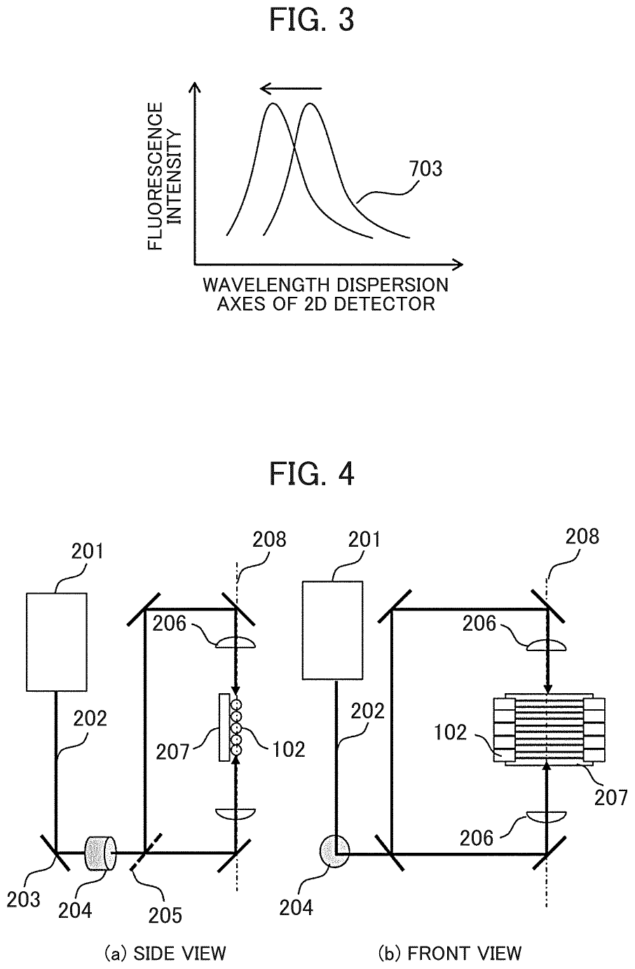

The description below outlines false signals due to spectral shifts. FIG. 2 is a diagram illustrating a state in which a DNA band separated by electrophoresis moves inside the capillary. Condensed laser light is irradiated to the detection portion 116 of the capillary 102 and contains an irradiation region 702 of a predetermined width. The signal acquired by the 2D detector 115 varies while a DNA band 701 enters the irradiation region 702 of the laser light and leaves it. Since the migration direction is equal to the wavelength dispersion direction, the DNA band 701 moves in the wavelength dispersion direction while passing through the irradiation region 702 of the laser light. The emission spectrum 703 of the signal acquired by the 2D detector 115 apparently varies as illustrated in FIG. 3.

FIG. 3 is a graph illustrating a change in the emission spectrum. The spectral shift illustrated in FIG. 3 provides the same effect as the time-dependent change in the wavelength of the emission spectrum 703 while the DNA band 701 passes through the irradiation region 702 of the laser light. The electrophoresis uses a plurality of fluorescent dyes that correspond to four types of bases. An apparent change in the emission spectrum 703 disables complete correspondence (matrix transformation) between the observed emission spectrum 703 and each fluorescent dye or base. The matrix transformation applied to each component of the emission spectrum 703 generates a false signal as a residual component incapable of transformation. The false signal decreases the capability of identifying fluorescent dyes or causes misdiagnosis. An increase in the irradiation region 702 of the laser light increases the false signal due to spectral shifts.

### First Embodiment

FIG. 4 is a schematic diagram illustrating a laser light path in an optical irradiation system of the electrophoresis device according to the first embodiment. The light irradiation mechanism 114 according to the present embodiment includes a laser unit 201 as a light source to oscillate a laser light 202, a beam splitter 205 to split the laser light 202 into two, a reflective mirror 203 to change the path of the laser light 202, and a condensing lens 206 to condense the laser light 202. A polarization-dependent optical isolator 204 is inserted in the optical path between the laser unit 201 and the beam splitter 205. The reflective mirror 203 guides one of the laser lights 202 split by the beam splitter 205 below the capillary array and the other above the capillary array. Each laser light 202 is condensed by the condensing lens 206 and then enters the capillary array from the upper or lower end. The 2D detector 115 detects the fluorescence emitted from the detection portion 116 of each capillary 102.

While FIG. 4 illustrates only five capillaries 102, the capillary array is composed of 24 capillaries 102 according to the present embodiment. Each capillary 102 is aligned and secured to the reference base 207 in the detection portion 116. Throughout the specification, the capillary array plane signifies a virtual plane formed by the central axis (capillary axis) of each capillary on the reference base 207. The optical axis 208 signifies a virtual line that belongs to the capillary array plane and is perpendicular to each capillary axis While the present embodiment configures the capillary array made of 24 capillaries 102, the number of capillaries 102 is not limited to 24.

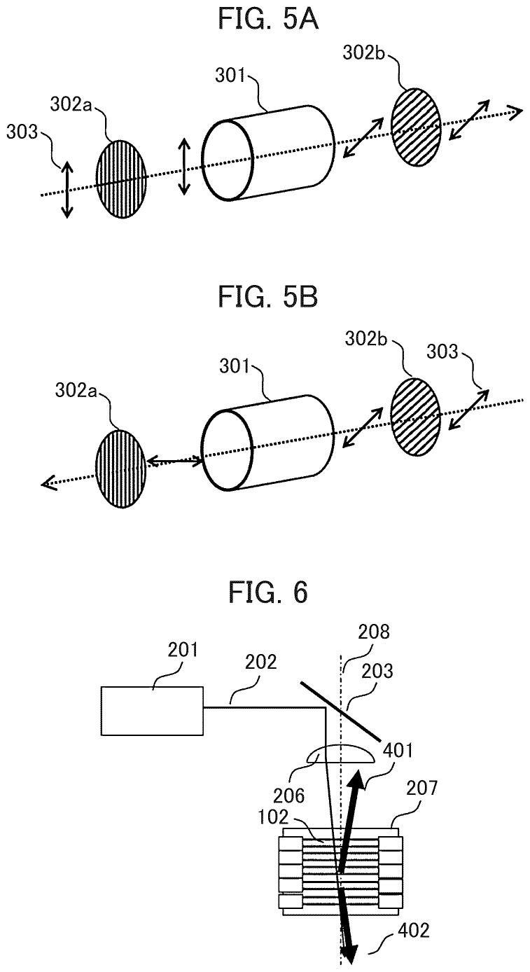

The description below explains the light-shielding principle of the polarization-dependent optical isolator 204 by reference to FIGS. 5A and 5B. FIG. 5A is a diagram illustrating how laser light enters a polarization-dependent optical isolator in the forward direction, and FIG. 5B is a diagram illustrating how the return light enters a polarization-dependent optical isolator in the reverse direction. The polarization-dependent optical isolator 204 includes a first polarizer 302a, a second polarizer 302b, and a Faraday rotator 301 placed between the first polarizer 302a and the second polarizer 302b. The second polarizer 302b is installed by slanting the transmission axis 45° against the first polarizer 302a. The Faraday rotator 301 rotates the polarization direction 303 by a predetermined angle regardless of an incident or polarization direction. The present embodiment uses the Faraday rotator 301, which rotates the polarization direction by 45°. The direction of rotating the polarization direction 303 rotated by the Faraday rotator 301 based on forward incident light is opposite to that of the polarization direction 303 rotated by the Faraday rotator 301 based on reverse incident light.

When the laser light enters the polarization-dependent optical isolator 204 in the forward direction as illustrated in FIG. 5A, the laser light passes through the first polarizer 302a, allows the polarization direction to be rotated 45° by the Faraday rotator 301, and enters the second polarizer 302b. The laser light passes through the second polarizer 302b whose transmission axis is tilted 45°.

When the return light enters the polarization-dependent optical isolator 204 in the reverse direction as illustrated in FIG. 5B, the return light passes through the second polarizer 302b, allows the polarization direction to be rotated 45° by the Faraday rotator 301 in the direction reverse to the forward direction, and enters the first polarizer 302a. The polarization direction of the return light at this time is perpendicular to the transmission axis of the first polarizer 302a, allowing the first polarizer 302a to shield the return light.

The description below outlines the reflected return light and the transmitted return light by reference to FIG. 6. FIG. 6 is a conceptual diagram illustrating transmitted and reflected return light when laser light is irradiated to a capillary array. FIG. 6 illustrates the incident light on the capillary array to be slightly tilted from the direction perpendicular to the capillary axis to facilitate understanding of the transmitted and reflected light from the capillary array.

The laser light 202 incident on the capillary array reflects off the interface between the air and an outer wall of the capillary and the interface between an inner wall of the capillary and the gel. In particular, the former interface increases a refractive index and consequently increases reflected light intensity. One capillary includes two interfaces between the air and the outer wall of the capillary. The capillary array composed of 24 capillaries causes a total of 48 reflections to occur off the interface between the air and the outer wall of the capillary. When the reflected return light 401 from the capillary array reaches the laser unit 201 as a light source, the laser unit 201 causes unstable laser oscillation.

Transmitted return light 402 passes through the capillary array and is emitted from the side opposite to the incident side. The transmitted return light 402 is attenuated by the amount of reflected light compared to the incident light. When the transmitted return light 402 reaches the laser unit 201, the laser unit 201 causes unstable laser oscillation.

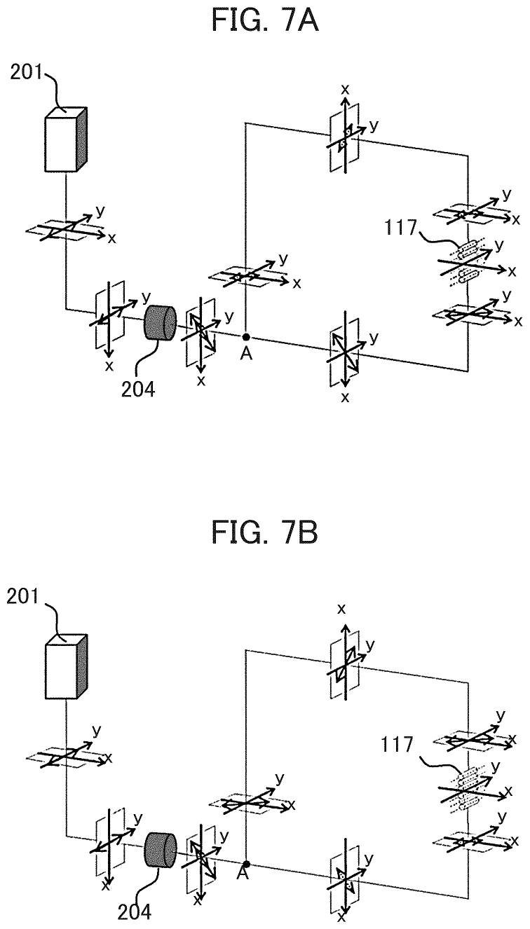

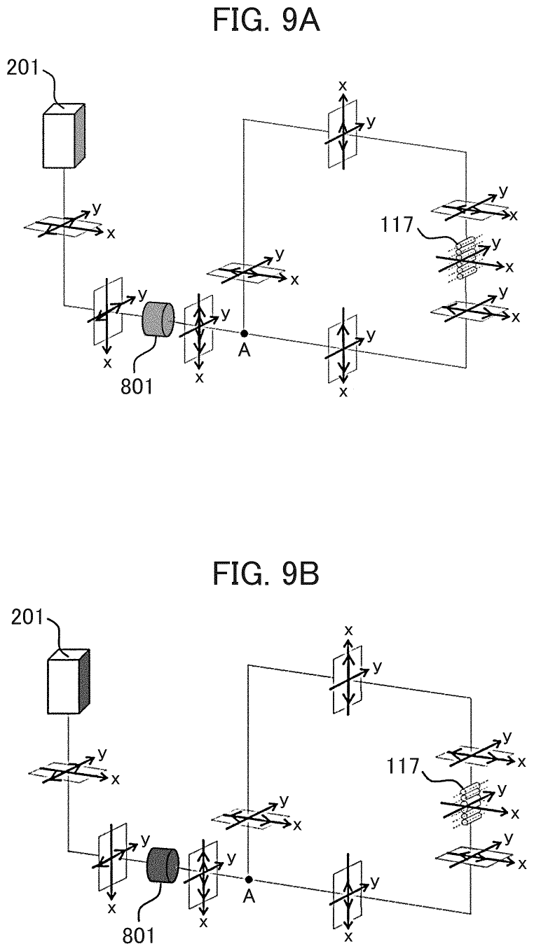

FIG. 7A is a diagram illustrating linear polarization states of the laser light and its transmitted return light when the laser light enters the polarization-dependent optical isolator and then is irradiated to the capillary array from below. xy planes in FIG. 7A are perpendicular to the travel direction of the laser light and illustrate linear polarization states at the corresponding positions (similar to FIGS. 7B, 9A, and 9B). FIG. 7 omits the mirrors and illustrates point A as the beam splitter position. The laser light emitted from the laser unit 201 enters the polarization-dependent optical isolator 204 while maintaining the linear polarization state in the x-axis direction. The laser light enters the polarization-dependent optical isolator 204 in the forward direction and passes through by rotating the linear polarization 45° as illustrated in FIG. 5A. The laser light travels straight through the beam splitter (point A) and enters the capillary array 117 from below while keeping the polarization angle of 45°. The transmitted return light passes through the capillary array 117, travels along the other laser path, re-enters the polarization-dependent optical isolator 204 in the reverse direction, and is shielded by the first polarizer 302a as illustrated in FIG. 5B. Though not shown in FIG. 7A, the reflected return light follows the incident light path and enters the polarization-dependent optical isolator 204 at the same polarization angle, and is consequently shielded similarly to the transmitted return light.

FIG. 7B is a diagram illustrating polarization states of the laser light and its transmitted return light when the laser light enters the polarization-dependent optical isolator and then is irradiated to the capillary array from above. Similar to FIG. 7A, the laser light emitted from the laser unit 201 enters the polarization-dependent optical isolator 204 while maintaining the linear polarization state in the x-axis direction, and passes through the polarization-dependent optical isolator 204 by rotating the linear polarization rotated 45°. The laser light reflected off the beam splitter (point A) enters the capillary array 117 from above while keeping the polarization angle of 45°. The transmitted return light passes through the capillary array 117, follows the other laser path, then re-enters the polarization-dependent optical isolator 204, and is shielded by the first polarizer 302a similarly to the case in FIG. 7A. Though not shown in FIG. 7B, the reflected return light follows the path of the incident light, enters the optical isolator at the same polarization angle, and is consequently shielded similarly to the transmitted return light.

Even if the laser light irradiated to the capillary array disorders the polarization state and varies polarization angles of the return light, only the linear polarization with a polarization angle of 45° passes through the second polarizer 302b and enters the Faraday rotator 301 as illustrated in FIG. 5B according to the present embodiment. The Faraday rotator 301 rotates the polarization direction of the return light in the direction reverse to the forward direction, allowing the first polarizer 302a to shield the return light. The polarization-dependent optical isolator according to the present embodiment reliably shields the return light even if the laser light irradiated to the capillary array disorders the linear polarization state. It is possible to use laser units less resistant to return light, increasing the degree of freedom in selecting laser devices. The laser light is irradiated from both ends of the capillary array along the same optical axis perpendicular to the capillary axis, narrowing the irradiation region of the laser light and reducing false signals due to spectral shifts. As a result, the sample separation performance of the electrophoresis device is improved.

### Second Embodiment

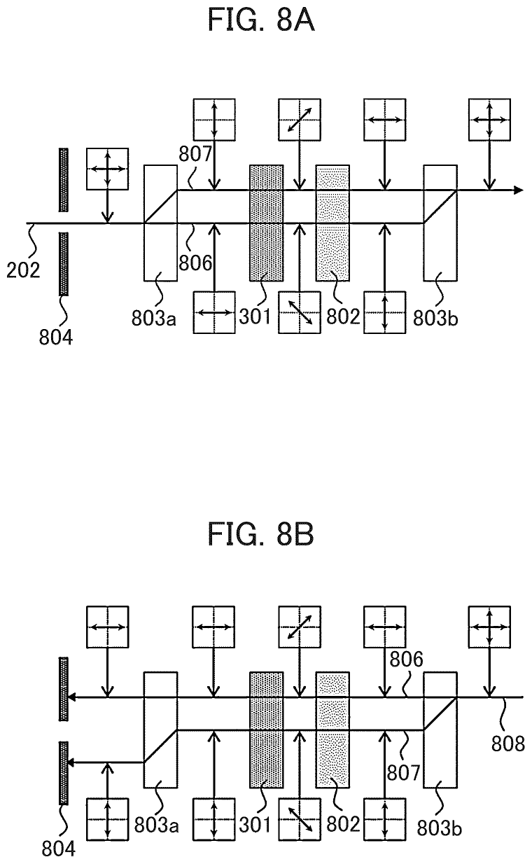

The description below explains the optical irradiation system of the electrophoresis device according to the second embodiment by reference to FIGS. 8A to 9B. Unlike the first embodiment, the light irradiation mechanism 114 according to the present embodiment functions as an optical isolator and includes a polarization-independent optical isolator 801.

As illustrated in FIG. 8A and FIG. 8B, the polarization-independent optical isolator 801 includes a first doubly refracting crystal 803a, a second doubly refracting crystal 803b, the Faraday rotator 301 placed between the first doubly refracting crystal 803a and the second doubly refracting crystal 803b, a half-wave plate 802 placed between the first doubly refracting crystal 803a and the second doubly refracting crystal 803b, and a pinhole plate 804.

The present embodiment uses the half-wave plate 802 as well as the Faraday rotator 301 same as that used in the first embodiment. Like the Faraday rotator 301, the half-wave plate 802 rotates the polarization direction 45°. Unlike the Faraday rotator 301, the direction of rotating the polarization direction 303 rotated by the half-wave plate 802 based on forward incident light is equal to that of the polarization direction 303 rotated by the half-wave plate 802 based on reverse incident light.

FIG. 8A is a diagram illustrating an optical path of the laser light entering the polarization-independent optical isolator in the forward direction and the polarization direction at each position as viewed from the beam travel direction. The laser light 202 traveling in the forward direction passes through a pinhole of the pinhole plate 804 and enters the first doubly refracting crystal 803a. The first doubly refracting crystal 803a splits the laser light 202 into an ordinary ray 806 and an extraordinary ray 807 that differ in the polarization directions by 90° due to refractive index differences in the respective axial directions. According to the present embodiment, the polarization of the ordinary ray 806 is perpendicular to the plane in FIG. 8A. The Faraday rotator 301 rotates the rays 45°, which are then rotated another 45° by the half-wave plate 802 in the same direction to rotate the polarization direction a total of 90°, and are recombined by the second doubly refracting crystal 803b.

FIG. 8B is a diagram illustrating an optical path of the return light entering the polarization-independent optical isolator in the reverse direction and the polarization direction at each position as viewed from the beam travel direction. The return light 808 traveling in the reverse direction enters the second doubly refracting crystal 803b and is split into the ordinary ray 806 and the extraordinary ray 807. The half-wave plate 802 rotates the rays 45°, which are then rotated another 45° by the Faraday rotator 301 in the reverse direction, and enter the first doubly refracting crystal 803a while keeping the polarization direction unchanged. The polarization direction of each ray in the first doubly refracting crystal 803a is unchanged after passing through the second doubly refracting crystal 803b. The rays are not recombined, separately pass through the first doubly refracting crystal 803a, and are shielded by the pinhole plate 804.

FIG. 9A is a diagram illustrating linear polarization states of the laser light and its transmitted return light when the laser light enters the polarization-independent optical isolator and then is irradiated to the capillary array from below. The laser light enters the polarization-independent optical isolator 801 in the forward direction and passes through it as illustrated in FIG. 8A. The laser light travels straight through the beam splitter (point A) and then enters the capillary array 117 from below. The transmitted return light passes through the capillary array 117, straight follows the other laser path, re-enters the polarization-independent optical isolator 801 in the reverse direction, and is shielded by the pinhole plate 804. Though not shown in FIG. 9A, the reflected return light follows the incident light path, then re-enters the polarization-independent optical isolator 801, and is shielded like the transmitted return light.

FIG. 9B is a diagram illustrating linear polarization states of the laser light and its transmitted return light when the laser light enters the polarization-independent optical isolator and then is irradiated to the capillary array from above. The laser light enters and passes through the polarization-independent optical isolator 801 similar to FIG. 9A. The laser light reflected by the beam splitter (point A) enters the capillary array 117 from above. The transmitted return light passes through the capillary array 117, straight follows the other laser path, re-enters the polarization-independent optical isolator 801 and is shielded by the pinhole plate 804. Though not shown in FIG. 9B, the reflected return light follows the incident light path, then re-enters the polarization-independent optical isolator 801, and is shielded like the transmitted return light.

The polarization-dependent optical isolator according to the first embodiment provides a high level of the return light suppression effect because the polarizer shields light other than that of a specific polarization angle despite return light variations. The polarization-independent optical isolator according to the present embodiment can also be expected to provide a certain level of the return light suppression effect. The present embodiment can also use laser units less resistant to return light, increasing the degree of freedom in selecting laser devices. The narrow irradiation region of the laser light reduces false signals due to spectral shifts, improving the sample separation performance of the electrophoresis device.

The present invention is not limited to the above-described embodiments, and further includes various modifications. For example, the above-described embodiments use one optical isolator on the optical path from the light source to the beam splitter. Alternatively, it may be favorable to provide an optical isolator on each optical path after splitting by the beam splitter.

### LIST OF REFERENCE SIGNS

101: electrophoresis device, 102: capillary, 103: pump mechanism, 104: high-voltage power supply, 105: array holder, 106: plunger pump, 107: block, 108: check valve, 109: polymer container, 110: anode buffer container, 111: anode electrode, 112: capillary head, 113: motorized valve, 114: light irradiation mechanism, 115: 2D detector, 116: detection portion, 117: capillary array, 118: thermostatic bath, 119: fan, 120: heating and cooling mechanism, 121: buffer container, 122: washing container, 123: waste container, 124: sample container, 125: transport mechanism, 126: hollow electrode, 127: capillary cathode end, 128: chamber, 129: load header, 130: moving stage, 131: grip, 201: laser unit, 202: laser light, 203: reflective mirror, 204: polarization-dependent optical isolator, 205: beam splitter, 206: condensing lens, 207: reference base, 208: optical axis, 301: Faraday rotator, 302a: first polarizer, 302b: second polarizer, 303: polarization direction, 401: reflected return light, 402: transmitted return light, 701: DNA band, 702: irradiation region, 703: emission spectrum, 801: polarization-independent optical isolator, 802: half-wave plate, 803a: first doubly refracting crystal, 803b: second doubly refracting crystal 804: pinhole plate, 806: ordinary ray, 807: extraordinary ray, 808: return light

1. An electrophoresis device that irradiates a laser light from both ends of a capillary array composed of a plurality of capillaries lined up and detects light from the capillaries,
wherein an optical path from a light source of the laser light to the capillary array is provided with an optical isolator that shields not only reflected return light from the capillary array but also transmitted return light.

2. The electrophoresis device according to claim 1,
wherein the laser light is irradiated from both ends of the capillary array along the same optical axis perpendicular to a capillary axis and parallel to a plane to place the capillary array.

3. The electrophoresis device according to claim 1, comprising:
a beam splitter that splits the laser light emitted from the light source into two; and
a mirror that guides the split laser light to one side and the other side of the capillary array,
wherein the optical isolator is provided on an optical path from the light source to the beam splitter.

4. The electrophoresis device according to claim 1,
wherein the optical isolator is a polarization-dependent optical isolator including a first polarizer, a second polarizer, and a Faraday rotator placed between the first polarizer and the second polarizer.

5. The electrophoresis device according to claim 1,
wherein the optical isolator is a polarization-independent optical isolator including a first doubly refracting crystal, a second doubly refracting crystal, a Faraday rotator placed between the first doubly refracting crystal and the second doubly refracting crystal, and a half-wave plate placed between the first doubly refracting crystal and the second doubly refracting crystal.
